(19) United States
(12) Patent Application Publication
(10) Pub. No.: US 2006/0100963 A1
(43) Pub. Date: May 11, 2006

(54) Recommender and method of providing a recommendation of content therefor

(76) Inventors: Nathalie Dorothee Pieternel Leurs, Eindhoven (NL); Ronald Marcel Tol, Eindhoven (NL); Nicoline Haisma, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/533,754

(22) PCT Filed: Oct. 15, 2003
(86) PCT No.: PCT/IB03/04571

§ 371 Date: May 4, 2005

(30) Foreign Application Priority Data
Nov. 8, 2002 (EP) 02079681.9

(51) Int. Cl. G06Q 99/00

(52) U.S. Cl. 705/51

(57) ABSTRACT

The invention relates to a system for recommending content items. A user profile processor (113) determines (201) a user preference profile for a user for different categories of content. When a content item is received (203), a recommender processor (111) determines (205) if a first content item correlates with the user preference profile. If there is such an associative correspondence, the content item is recommended (206) to the user. If not, the recommender processor (111) determines (211) if the received content item comprises at least a first characteristic having an associative correspondence to at least a second characteristic of a second content item having a high user preference. If there is such an associative correspondence, the received content item is recommended to the user. The associative correspondence may be determined to exist if textual descriptions for the two content items comprise similar words. The invention allows an increased diversity in recommendations and is particularly suitable for a Private Video Recorder.

### FIELD OF THE INVENTION

The invention relates to a recommender and a method of providing a recommendation of content therefor and in particular to a recommender suitable for a Private Video Recorder.

### BACKGROUND OF THE INVENTION

In recent years, the accessibility to and provision of information and content such as TV programmes, film, music and books, etc. have increased explosively. The information and content may today be provided from many different sources, and the variety and availability of content has increased substantially.

For example, the number of available television channels in most countries has increased substantially in the last decade, and in many countries, viewers can receive tens or even hundreds of different TV channels. The TV channels are further provided from different broadcasters and sources and are communicated through a variety of media including terrestrial radio broadcasts, cable distribution or satellite broadcasts. Similarly, the number of available radio channels has increased explosively and are provided through different media such as satellite broadcasts, digital terrestrial broadcasts, cable distribution or even through the Internet.

As the available content has increased substantially, it has become increasingly difficult for a user to find and select the specific content that he is most interested in. Obtaining information of the total amount of content available and filtering this in order to select a desired content item is a very time-consuming and cumbersome process. In addition to finding the appropriate content item, the user further needs to determine from which source and at which time the desired content item is available.

In order to facilitate content selection, and to filter the available content to provide a suitable selection for a given user, recommenders have been developed, which are able to monitor the available content and, in response to a user profile, recommend content considered specifically suited for the user.

One area where recommenders have been implemented is in Private Video Recorders (PVRs). A typical PVR comprises a hard disk for recording content items such as TV programmes. The PVR further comprises a recommender, which records and recommends TV programmes to the user in accordance with a user profile. The user profile is built up over time to match the user's viewing habits, and the profile is specifically generated from specific user input related to the preference for a given programme as well as from detecting which programmes are selected for viewing by the user of the PVR.

Although conventional recommenders may facilitate content selection and provide recommendations, further improvement of the functionality provided would be advantageous.

For example, as the user profile is built up over a significant time, it tends to become relatively static, and modifications and updates can only gradually be incorporated. Furthermore, the user profile is determined in response to the user's preference for selected programmes. However, as the user typically selects items recommended to him from the content, the update information available for the user preference profile is typically limited to content already recommended. Thus, the content recommendation will tend to become more and more narrow with only content of a limited range being recommended. Thus, over time, the variety of recommendations becomes severely limited in conventional recommenders.

Hence, a system for an improved recommender would be advantageous, and especially a system providing increased flexibility and/or variety of recommendations.

### OBJECT AND SUMMARY OF THE INVENTION

Accordingly, the invention seeks to provide an improved system for a recommender and/or to mitigate, alleviate or eliminate one or more of the above-mentioned disadvantages singly or in any combination.

According to a first aspect of the invention, a method of providing a recommendation of content to a user comprises the steps of: determining a user preference profile for a user; determining if a first content item correlates with the user preference profile so as to have a high preference value; and if the first content item has a high preference value recommending it to a user; and if the first content item does not have a high preference value: determining if the first content item comprises at least a first characteristic having an associative correspondence to at least a second characteristic of a second content item having a high user preference and recommending it to the user only if there is such an associative correspondence.

Hence, an increased variety may be introduced in the recommendations as content items not specifically matching the current user preference profile may be recommended to the user. However, these content items are not randomly selected but may be selected in response to an associative correspondence between a first characteristic of the first content item and a second characteristic of a second preferred content item. Hence, the recommended content items will be related to content items known to have a high preference. Consequently, content items may be recommended on the basis of a relatively loose association with other preferred content items. This allows alternative content items that do not closely match the user preference profile to be recommended while increasing the probability that the recommended content item is suited for the user. Hence, the invention provides an efficient method of expanding and increasing the variety of recommendations.

The increased variety may further be used to update the user preference profile such that the preference information may be expanded into, for example, new categories of content. Thus a widening mechanism may be introduced to the user preference profile thereby opposing the narrowing effect caused by a limited recommendation of content for preference evaluation. The content items may be, for example, TV programmes, video clips, audio clips, radio programmes, music clips, multimedia clips or any other suitable content items.

According to a feature of the invention, the first content item is recommended to the user if only a single associative correspondence between the first characteristic and the second characteristic is determined. Specifically, a single associative correspondence between the first and the second content item may be sufficient to result in a recommendation. This allows for increased diversity of content items to be recommended. Specifically, it may be required that no more than one associative correspondence is determined in order for the content item to be recommended. This will allow that some of the content items recommended are significantly different than the currently preferred content items.

According to another feature of the invention, the associative correspondence is determined only for a single first and second characteristic. This may provide for a recommendation of a content item which is correlated with one or more preferred content items but at the same time has a high probability of not being too closely related to the preferred content items.

According to another feature of the invention, the method further comprises the step of determining a user preference for the first content item recommended from the associative correspondence and updating the user preference profile in response to the user preference. This allows the user preference profile to be updated with preference values for content items that currently have no or low preference ratings. Hence, the user preference profile may be updated to include positive preferences for new categories of content, thereby allowing the future recommendations to become more varied and diversified. The increased variation is thus not limited to the current recommendations but may be achieved for future recommendations.

According to another feature of the invention, the first characteristic is a first content description characteristic of the first content item and the second characteristic is a second content description characteristic of the second content item. Any suitable characteristic or attribute of the content descriptions, such as meta-data, may be used. This provides for the association between the first and second content items to be based on the content characteristics, thereby improving the probability that the first content item has a content that suits the user.

According to another feature of the invention, the first content description characteristic is derived from a first textual description associated with the first content item and the second content description characteristic is derived from a second textual description associated with the second content item. Text-based content description is typically prevalent for broadcast content. It is furthermore easy to access and process. The use of text-based content descriptions therefore provides a suitable and easy to implement basis for determining an associative correspondence.

According to another feature of the invention, the associative correspondence is determined in response to an identification of a correspondence between at least one word of the first textual description and at least one word of the second textual description. This provides a simple yet highly efficient way of determining the associative correspondence between content items.

According to another feature of the invention, the correspondence is determined in response to the at least one word of the first textual description having a similar meaning as the at least one word of the second textual description. This provides for only simple processing to be required to determine an associative correspondence, yet allows content items to be recommended that differ from currently preferred content while having a reasonable probability of being selected and/or preferred by the user.

According to another feature of the invention, the correspondence is determined in response to at the least one word of the first textual description having an associative word correspondence to the at least one word of the second textual description, the associative word correspondence being determined from a database of word associations. Hence, the associative correspondence may not (or not exclusively) be determined by words having identical or similar meanings but may also be determined in response to words being associated with each other. A list of associations between words may be stored in a data base and accessed to determine the associative correspondence.

According to another feature of the invention, the associative correspondence is determined in response to word combinations of at least one of the first and second textual content description. This may provide an increased flexibility and accuracy of determining the associative correspondence between the first and the second characteristic.

According to another feature of the invention, at least one of the first and second characteristics is determined from a content analysis of the content item. Specifically, the content analysis may comprise a content item video image analysis, such as a content item video object analysis, and/or a content item audio analysis. This allows the associative correspondence to be determined on the basis of only the content items without requiring any additional information.

According to another feature of the invention, wherein at least one of the first and second characteristic is determined from a content item broadcast channel, the first and second characteristics may be associated with characteristics of the first and second content items in relation to the content item broadcast channel. This may, for example, include a time of broadcast of the content item. This provides an additional or alternative method of determining an associative correspondence allowing the recommendation of probably suitable but currently non-preferred content items.

According to another feature of the invention, the step of determining the associative correspondence comprises determining a plurality of associative correspondences between a plurality of characteristics of the first content item and a plurality of characteristics of the second content item. This allows the probability of the first content item to be suited for the user to be increased.

According to another feature of the invention, the associative correspondence is further determined in response to a previous associative correspondence between content items. This allows the system to learn from previous behaviour. Specifically, if some types of associative correspondence have been found to result in content being recommended that has received high user preference indications, this associative correspondence may be used increasingly in the future. Hence, it provides an increased probability that recommended content items are suitable for the user.

According to another feature of the invention, at least one of the first and second characteristics is chosen from the group of: an actor; a character played by an actor; and a location. These characteristics provide a suitable basis for determining associative correspondences that result in diverse recommendations, yet with a reasonable probability of suiting the user.

According to a second aspect of the invention, there is provided a recommender for providing a recommendation of content to a user, the recommender comprising: a user profile processor for determining a user preference profile for a user; a recommender processor for determining if a first content item correlates with the user preference profile so as to have a high preference value; and if the first content item has a high preference value recommending it to a user, and if the first content item does not have a high preference value: determining if the first content item comprises at least a first characteristic having an associative correspondence to at least a second characteristic of a second content item having a high user preference and recommending it to the user only if there is such an associative correspondence.

### BRIEF DESCRIPTION OF THE DRAWINGS

An embodiment of the invention will be described, by way of example only, with reference to the drawings, in which

FIG. 1 is an illustration of a private video recorder comprising a recommender in accordance with an embodiment of the invention; and

FIG. 2 is an illustration of a method of providing a recommendation of content in accordance with an embodiment of the invention.

### DESCRIPTION OF PREFERRED EMBODIMENTS

The following description focuses on an embodiment of the invention applicable to a Private Video Recorder (PVR) comprising a recommender. However, it will be apparent that the invention is not limited to this application but may be applied to many other applications including recommenders for radio programme content or Internet content.

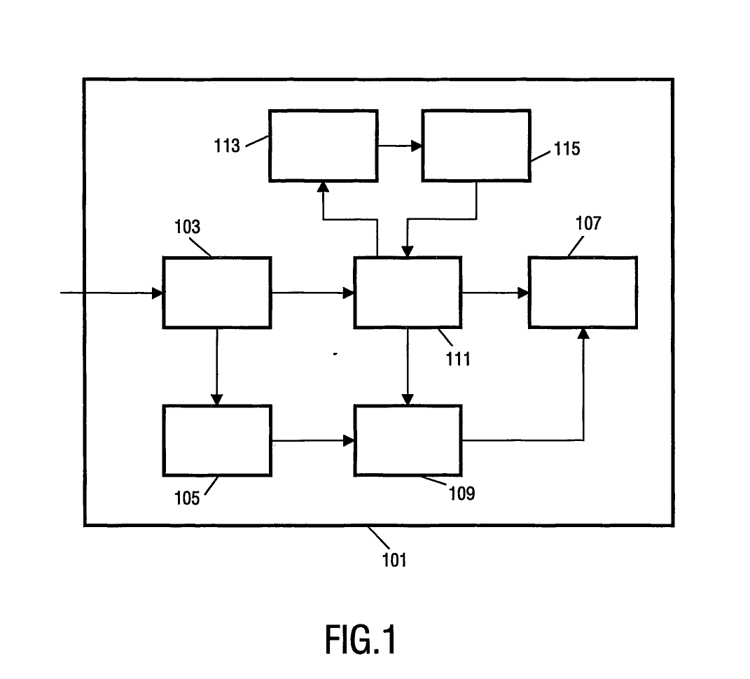

FIG. 1 is an illustration of a private video recorder (PVR) 101 comprising a recommender in accordance with an embodiment of the invention. The PVR 101 comprises a content receiver 103. The content receiver 103 receives content items from one or more suitable content item sources. In the preferred embodiment, the content receiver 103 mainly receives content by way of TV programmes broadcast in a suitable way.

Furthermore, in the preferred embodiment, the content receiver is capable of receiving content from a plurality of various content sources. Thus, the content receiver 103 receives content items in the form of video, audio and multimedia clips and programmes. Specifically, TV programmes are received from terrestrial radio broadcasts as well as from a digital cable connection. Likewise, radio programmes are received from conventional analogue radio transmissions as well as from digital radio broadcasts received through a cable connection. The content receiver 103 capable of receiving a plurality of content items from various sources may simply be implemented as the combination of a plurality of independent content receiver elements, where each element is dedicated to receiving content items of a specific nature from a specific source.

The received content items are converted to suitable digital formats and stored in a content memory 105 together with information associated with the content items. Specifically, a content item may be received directly in a suitable format, such as an MPEG 2 format for a video transmission, and in this case no conversion is required.

The PVR 101 further comprises a user interface 107 for displaying content items, control information and for receiving user input. Specifically, the user interface 107 comprises a display such as e.g. a video monitor or a TV. In the preferred embodiment, the user input is received by using a remote control communicating with the user interface 107. Hence, the user interface is operable to display various information to the user and to receive user inputs. Specifically, the user interface may display a list of content items, and a user may select one of these through a suitable activation of the remote control.

The PVR additionally comprises a content presenter 109, which is coupled to the content memory 105 and the user interface 107. In response to a selection of a content item, the content presenter 109 is operable to retrieve the stored content from the content memory 105 and present it to the user via the user interface 107.

Furthermore, the PVR 101 comprises a recommender processor 111 coupled to the content receiver 103, the content presenter 109, the user interface 107 and possibly the content memory 105. The recommender processor 111 is coupled to a user profile processor 113, which is operable to generate and maintain a user preference profile for a user of the PVR 101.

In the preferred embodiment, the recommender processor 111 detects which content items are presented by the content presenter 109. It furthermore determines a user preference for the content items through a specific user preference indication received through the user interface 107. Additionally or alternatively, the user preference indication may be received through indirect measures. These indirect measures include detection of, for example, how many times a given content item is watched, whether it is watched in full or only partly, etc.

When the recommender processor 111 detects that a given content item is presented to the user, it retrieves the associated information from the content memory 105. The user preference is correlated with the information for the content item, and specifically with the category of the content item, in order to derive information of the user's preference for this category of content item.

This information is forwarded to the user profile processor 113, which through receiving a plurality of such indications builds up knowledge of the user's preferences for different categories and types of content. This knowledge is contained in a user preference profile, and the PVR 101 comprises a user preference profile memory 115 for storing the user preference profile. The user preference profile memory 115 is coupled to the user profile processor 113.

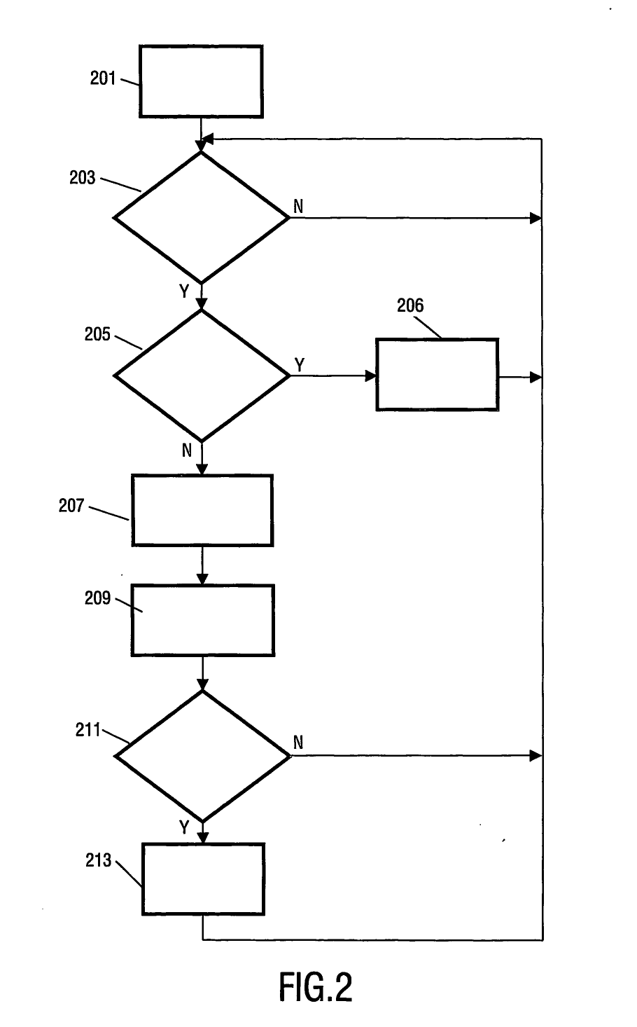

FIG. 2 is an illustration of a method of providing a recommendation of content in accordance with an embodiment of the invention. The method may be applicable to the PVR of FIG. 1, and will hereinafter be described with reference thereto.

In step 201, a user preference profile is determined. In the preferred embodiment, the user preference profile is determined in response to previous user selections. Hence, specifically a user preference profile is generated when the PVR 101 is first initiated and is then stored in the user preference profile memory 113. The user preference profile is continually updated as the PVR 101 is used, and becomes increasingly accurate and specific as more and more information is determined. The determination of the user preference profile of step 201 may comprise the process of generating a new user preference profile. However, in the preferred embodiment, the determination of step 201 comprises the recommender processor 111 determining the user preference profile simply by accessing the information stored in the user preference profile memory 113. Hence, the determination preferably simply consists in retrieving or accessing some or all information of the user preference profile stored in the user preference profile memory 113.

In step 203, it is determined if a new content item has been received. The step is repeated until a content item is received. When a first content item is received by the content receiver 103, it is stored in the content memory 105. In addition, content information is fed to or extracted by the recommender processor 111.

When the first content item has been received, the method continues in step 205 wherein it is detected if the first content item correlates with the user preference profile so as to have a high preference value, and specifically in the preferred embodiment, whether it matches the user's current user preference profile. The determination is based on the content information determined in step 203. If the first content item does match the user preference profile, the method continues in step 206 by the recommender processor 111 recommending the content item to the user. The method then returns to step 203.

If the first content item does not match the user preference profile, the method continues in step 207. In step 207, one or more characteristics associated with the first content item is extracted by or fed to the recommender processor 111. The first characteristic may be any suitable characteristic, but in the preferred embodiment it comprises information related to the content of the first content item. Specifically, the first characteristic may comprise one or more suitable content description indicators. Typically, the first characteristic is a specific parameter or characteristic related to a specific attribute of the content of the content item. For example, if the content item is a video programme such as a film, the first characteristic may relate to an actor in the film, to a specific character played by an actor or to a specific location included in the film. Thus as a specific example, the first characteristic may relate to the main role being played by a specific actor or to the character played by a specific actor. The first characteristic may further comprise a plurality of different attributes. A specific example of a first characteristic is information that the film includes Arnold Schwarzenegger playing a robot in a future metropolis.

The method continues in step 209 by determining at least a second characteristic of at least a second content item. The second characteristic may be any suitable characteristic including the characteristics described in the previous paragraph for the first characteristic. The second characteristic is preferably determined for a specific second content item which is known to have a high preference value. However, in some embodiments, the second characteristic relates to more than a single second content item. Specifically, the second characteristic may be determined from a content category of the user preference profile comprising the second content item and having a high preference value.

The method continues in step 211, wherein it is determined if the first characteristic has an associative correspondence to at least the second characteristic. Hence, it is determined if there is any connection or relation between the first and second characteristics. The association between the first and second characteristic may, for example, consist in an attribute of the first characteristic being similar or identical to an attribute of the second characteristic. However, the first and second characteristics need not be of an identical or similar type of attribute, but the association may be related across different types of attributes. For example, an associative correspondence may exist between a specific actor identified in the first characteristic and a specific character identified in the second content item because it is known that the actor is associated with this character. Thus, an associative correspondence may exist between an identification of Sean Connery in the first characteristic and an identification of James Bond in the second characteristic.

If an associative correspondence is found to exist, the method continues in step 213 by recommending the first content item. Otherwise, the method returns to step 203 or step 201. Thus, as a specific example, a content item comprising Sean Connery as an actor may be recommended because the user preference profile indicates that the user has a high preference for James Bond-associated content items.

The associative correspondence may be determined in response to more than just the first and second characteristics, and each of the first and second characteristics may comprise a plurality of different information elements and/or attributes. However, in the preferred embodiment, the associative correspondence is much more limited than the matching between the content item and the user preference profile. Specifically, the associative correspondence may be based on only one characteristic and attribute of the first and second content item, or even require that only one associative correspondence exists between them. This will ensure that, although the recommended content item is related to known preferred content items, this relation is not a close relationship, and that therefore the recommended content item will differ significantly from the preferred content items of the user preference profile.

Many different methods, rules and/or algorithms can be used to determine the associative correspondence, and the determination may be based on any suitable determination and nature of the first and second characteristics.

However, in the preferred embodiment, the first characteristic is a first content description characteristic of the first content item and the second characteristic is a second content description characteristic of the second content item. Thus both characteristics relate to the content of the content items.

Specifically, the first content characteristic may be derived from a first textual description associated with the first content item, and the second characteristic may be derived from a second textual description associated with the second content item. Thus the associative correspondence is determined in response to textual descriptions of the first and second content items. The text descriptions may be received in any suitable way and form. However, in the preferred embodiment, the text descriptions of content items are received through an Electronic Programme Guide (EPG). The EPG is either received as part of the received broadcast, or is communicated to the PVR 101 through other means, including from the Internet or through a direct data connection to a central unit.

In one embodiment, the associative correspondence is determined by detecting if at least one word of the first text description for the first content item corresponds to at least one word of the second text description for the second content item. The correspondence may be determined to exist, if the two text descriptions comprise words that are identical or similar. In this comparison, many general words such as “is”, “the”, etc. are naturally ignored. For example, the PVR 101 may comprise a list of words to ignore when making the comparison.

A word similarity test for correspondence will allow content item to be recommended on the basis of only a limited correlation between the first content item and a preferred content item. As a specific example, a description of the movie “Blue Lagoon” is likely to comprise words similar to what can be found in the description of a documentary about tropical islands. Thus if the user has rated the movie very highly, the documentary about tropical islands may be recommended. As another specific example, both the description of the movie “Magnolia” and the movie “The Player” may comprise the words ‘ . . . intertwine many story lines . . . ’. The recommender may consequently recommend one of these based on a high preference for the other.

The words of the different text descriptions need not be identical but may just be similar or specifically may have similar meaning. For example, a correlation may be found between content items having text descriptions of “rat race” and “burn out” as these are used to describe similar issues. Furthermore, the correspondence may be determined to exist if an associative word correspondence exists between words of the different text descriptions. Preferably, the associative word correspondence is determined from a database of word associations. Hence, in one embodiment, the recommender incorporates or has access to associative dictionaries. Hence, the correspondence may be directly determined from the titles of the movie “Blue Lagoon” and the documentary “Bounty Island documentary” as the associative dictionary will indicate that the words “Bounty Island” are typically associated with “Blue Lagoon”. As another specific example, the movie “Magnolia” may be associated with the movie “Sound of Music” if the description of the latter mentions the song “Edelweiss”, in which case both descriptions comprise flower names.

In many embodiments, the associative correspondence is determined in response to word combinations of the first and second textual descriptions. For example, the title “Buffy the Vampire Slayer” may be associated with “Dracula”.

Additionally or alternatively to determining the associative correspondence in response to text descriptions, at least one of the first and second characteristic is determined from a content analysis of the content item. Hence, the associative correspondence is determined in response to a content analysis of the first content item, of the second content item or of both content items.

It is within the contemplation of the invention that any suitable method of content analysis may be used. In the preferred embodiment, the content analysis simply comprises extracting meta-data from the content item signal indicative of the content of the content item. Thus, the broadcaster in this embodiment includes data related to the content of the video signal in the broadcast. The meta-data may either be embedded in the content item itself or may be provided as a separate logical or physical communication channel. Specifically, the meta-data may provide content description in accordance with the Multimedia Content Description Interface, MPEG 7 as standardised by the Moving Pictures Expert Group.

In more advanced embodiments, the content analysis does not require the presence of dedicated content description but operates directly on the content signal itself. In recent years, significant research has been carried out in the field of content analysis for e.g. video signals and any of the developed methods or algorithms for content analysis may be used without detracting from the invention.

Typically, content analysis is based on detecting specific characteristics typical of a category of content. For example, a video content item may be detected as relating to a football match by having a high average concentration of green colour and a frequent sideways motion. Cartoons are characterised by typically having strong primary colours, a high level of brightness and sharp colour transitions. Hence, these characteristics are used to determine content information and the associative correspondence is determined in response to the information derived. Thus, a received content item may be determined to be a cartoon, and if, for example, the user preference profile comprises a high preference value for the cartoon “The Simpsons”, the received content item will be recommended to the user.

Specifically, the content analysis may be a content item video object analysis. This is particularly suitable for object recognition and may be facilitated by using of MPEG-4 or MPEG 7 technology, wherein the content provider is required to tag objects with object information. In this embodiment, if it is determined that a preferred content item comprises a specific car, other content comprising that car may, for example, be recommended.

For audio content items, the content analysis may e.g. divide music into, for example, acoustic music (minimal low frequency rhythm), dance music (fast and high volume low frequency rhythm); slow music (slow rhythm), fast music (fast rhythm), etc. This may be used to recommend content item characteristics with an associative correspondence to the specific music category.

Further information on content analysis is generally available to the person skilled in the art. For example, the articles “Content-Based Multimedia Indexing and Retrieval” by C. Djeraba, IEEE Multimedia, April-June 2002, Institute of Electrical and Electronic Engineers; “A Survey on Content-Based Retrieval for Multimedia Databases” by A. Yoshika et al., IEEE Transactions on Knowledge and Data Engineering, vol. 11, No. 1, January/February 1999, Institute of Electrical and Electronic Engineers; “Applications of Video-Content Analysis and Retrieval” by N. Dimitrova et al., IEEE Multimedia, July-September 2002, Institute of Electrical and Electronic Engineers and the references included therein provide an introduction to content analysis.

Additionally and alternatively, at least one of the first and second characteristics is determined from a content item broadcast channel. Specifically, the first and/or second characteristic may be determined from a relationship between the first and/or second content item and the content item broadcast channel. In particular, the relationship may comprise a time of transmission of the first and/or second content item on the broadcast channel. This allows associative correspondences to be determined in response to, for example, when a content item is broadcast. Hence, content items may be associated if they are broadcast by the same broadcast channel at the same hour of the day (and therefore presumably have the same target group).

Preferably, a user preference for the first content item is received, and the user preference profile is updated in preference to this user preference. Hence, as a content item is suggested that does not match the current user preference profile, a user preference for this alternative content is determined. If the user likes the suggested content, the user preference profile is modified by including a positive preference value for the content category or categories associated with the recommended content item. This allows the variety and diversity of recommendations to be increased.

Preferably, the associative correspondence is further determined in response to a previous associative correspondence between content items. Hence, information is stored of the success of different associative correspondences. Thus, if a recommendation was made on the basis of a correspondence related to the actor in a movie, which resulted in a positive user preference, future associative correspondences will be examined on the basis of the actors involved in the content items.

The invention can be implemented in any suitable form including hardware, software, firmware or any combination of them. However, the invention is preferably implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims.

1. A method of providing a recommendation of content to a user the method comprising the steps of:
determining (201) a user preference profile for a user;
determining (205) if a first content item correlates with the user preference profile so as to have a high preference value; and
if the first content item has a high preference value recommending (206) it to a user; and
if the first content item does not have a high preference value:
determining (211) if the first content item comprises at least a first characteristic having an associative correspondence to at least a second characteristic of a second content item having a high user preference and recommending it to the user only if there is such an associative correspondence.

2. A method as claimed in claim 1, wherein the first content item is recommended to the user if only a single associative correspondence between the first characteristic and the second characteristic is determined.

3. A method as claimed in claim 1, wherein the associative correspondence is determined only for a single first and second characteristic.

4. A method as claimed in claim 1, further comprising the step of determining a user preference for the first content item recommended from the associative correspondence and updating the user preference profile in response to the user preference.

5. A method as claimed in claim 1, wherein the first characteristic is a first content description characteristic of the first content item and the second characteristic is a second content description characteristic of the second content item.

6. A method as claimed in claim 5, wherein the first content description characteristic is derived from a first textual description associated with the first content item and the second content description characteristic is derived from a second textual description associated with the second content item.

7. A method as claimed in claim 6, wherein the associative correspondence is determined in response to an identification of a correspondence between at least one word of the first textual description and at least one word of the second textual description.

8. A method as claimed in claim 7, wherein the correspondence is determined in response to the at least one word of the first textual description having a similar meaning as the at least one word of the second textual description.

9. A method as claimed in claim 7, wherein the correspondence is determined in response to the at least one word of the first textual description having an associative word correspondence to the at least one word of the second textual description, the associative word correspondence being determined from a database of word associations.

10. A method as claimed in claim 7, wherein the associative correspondence is determined in response to word combinations of at least one of the first and second textual content descriptions.

11. A method as claimed in claim 1, wherein at least one of the first and second characteristics is determined from a content analysis of the content item.

12. A method as claimed in claim 11, wherein the content analysis comprises a content item video image analysis.

13. A method as claimed in claim 11, wherein the content analysis comprises a content item audio analysis.

14. A method as claimed in claim 1, wherein at least one of the first and second characteristic is determined from a content item video object analysis.

15. A method as claimed in claim 1, wherein at least one of the first and second characteristics is determined from a content item broadcast channel.

16. A method as claimed in claim 1, wherein the step of determining the associative correspondence comprises determining a plurality of associative correspondences between a plurality of characteristics of the first content item and a plurality of characteristics of the second content item.

17. A method as claimed in claim 1, wherein the associative correspondence is further determined in response to a previous associative correspondence between content items.

18. A method as claimed in claim 1, wherein at least one of the first and second characteristics is chosen from the group of
a. an actor;
b. a character played by an actor; and
c. a location.

19. A computer program enabling a method to be carried out according to claim 1.

20. A recommender for providing a recommendation of content to a user, the recommender comprising:
a user profile processor (113) for determining a user preference profile for a user;
a recommender processor (111) for determining if a first content item correlates with the user preference profile so as to have a high preference value; and
if the first content item has a high preference value recommending it to a user; and
if the first content item does not have a high preference value:
determining if the first content item comprises at least a first characteristic having an associative correspondence to at least a second characteristic of a second content item having a high user preference and recommending it to the user only if there is such an associative correspondence.

21. A private video recorder (101) comprising a recommender as claimed in claim 20.
